(19) United States
(12) Patent Application Publication
(10) Pub. No.: US 2008/0193815 A1
(43) Pub. Date: Aug. 14, 2008

(54) Device and Method for Heating a Fuel Cell or a Fuel Cell Stack

(75) Inventors: Bruno Burger, Freiburg (DE); Jan Hesselmann, Muchen (DE); Mario Zedda, Freiburg (DE)

Correspondence Address: KAPLAN GILMAN GIBSON & DERNIER L.L.P., 900 ROUTE 9 NORTH, WOODBRIDGE, NJ, 07095, US

(73) Assignee: Fraunhofer-Gesellschaft Zur Forderung Der Angewandten Forschung e.V., Munchen (DE)

(21) Appl. No.: 11/908,453

(22) PCT Filed: Mar. 9, 2006
(86) PCT No.: PCT/EP06/02194

§ 371 Date: Nov. 26, 2007

(30) Foreign Application Priority Data
Mar. 18, 2005 (DE) 10 2005 012 617.0

(51) Int. Cl. H01M 8/02; H05B 1/00

(52) U.S. Cl. 429/26; 429/13; 219/162

(57) ABSTRACT

A fuel cell system includes a fuel cell stack which has at least one fuel cell and has at least one electrical connection per terminal, wherein the fuel cell stack is connected via the connections to an alternating voltage generating device for electrical heating of the fuel cell stack, a rectangular alternating voltage which is rounded-off at the edges being generated by the alternating voltage generating device.

The present invention relates, in the field of fuel cell technology, to a device and a method for heating a fuel cell or a fuel cell stack.

In the following, there is understood by the term fuel cell stack an arrangement of at least one fuel cell, i.e. single cell, generally however a plurality of fuel cells. If the fuel cell stack has more than one fuel cell, then the individual fuel cells of the fuel cell stack can be connected electrically in parallel and/or in series.

Fuel cell stacks or the individual fuel cells are devices in which an electrochemical reaction is used in order to obtain electrical energy. Such fuel cell systems have a potentially high energy density and are characterised in that, considered as a whole, the waste gases or the waste products during energy generation are reduced significantly in comparison with other current energy generating systems.

Fuel cell systems or the individual fuel cells convert chemical energy into electrical energy with the help of electrochemical reactions. The reactions thereby take place separately from each other in reaction chambers which are separated by an electrolytic ion conductor. Thus, for example in a hydrogen-operated polymer electrolyte membrane fuel cell (PEMFC), hydrogen is oxidised at the anode into protons. The protons migrate through the electrolytic membrane towards the cathode, whilst the electrons remain because of the electrical insulation properties of the membrane or are forced into an external electrical circuit. At the cathode, oxygen is reduced to water with the help of electrons and protons, said water being the only emission product of the hydrogen-operated PEMFC. In the direct methanol fuel cell (DMFC), the electrochemical reaction at the anode is the conversion of methanol and water into carbon dioxide, hydrogen ions and electrons. The hydrogen ions flow for example through a polymer- or plastic material membrane as electrolyte towards the cathode, whilst the free electrons flow through a consumer unit which is normally connected between the anode and the cathode. At the cathode, oxygen reacts with hydrogen ions and free electrons to form water. Hence the discharge of a DMFC comprises merely carbon dioxide and water.

At temperatures below 0° C., without external heating fuel cells or fuel cell stacks can start up only very slowly or with great problems. In order to achieve a rapid start of the fuel cell at low temperatures, the fuel cell or the individual fuel cells of the system must be heated. Methods according to prior art for such heating are heating with the help of heating foils or heating with the help of a thermal circuit with water as heat exchange fluid.

When using a thermal circuit with water as heat exchange fluid, disadvantages arise however in that very complex components are required for this purpose. Firstly a heating element must be incorporated in the cooling or heating circuit. The liquid in the cooling or heating circuit itself must likewise be heated, which leads to an additional energy requirement. A further aspect with respect to the high energy requirement concerns the requirement for a pump in order to pump the water round.

When using heating by means of a heating foil, the disadvantage arises here also that additional components are required. A further disadvantage concerns the fact that merely indirect heating is possible since the heat is not produced in the fuel cell but is supplied from outside.

It is the object of the present invention, starting from the state of the art, to make a fuel cell system available, the fuel cell stack of which or fuel cells of which can be heated simply and reliably and with sufficient speed. It is the object of the present invention in addition to make available a corresponding heating method for a fuel cell stack or for fuel cells.

This object is achieved by the fuel cell system according to claim 1 and by the heating method according to claim 14. Advantageous developments of the device according to the invention or of the method according to the invention respectively are described in the dependent claims.

A fuel cell system according to the invention has a fuel cell stack which has at least one fuel cell, is equipped with at least one electrical connection per terminal, i.e. positive and negative terminal, which can serve in particular for connection of an external electrical consumer unit and is characterised according to the invention in that the fuel cell stack is connected via the connections to an alternating voltage generating device so that, by means of the alternating voltage generating device, an electrical alternating current can be coupled to the fuel cells or the fuel cell stack in order to heat the fuel cell stack or the cells. The alternating voltage generating device here has advantageously, connected in series, an alternating voltage source and a direct voltage source or, connected in series, an alternating voltage source and a condenser. The alternating current can hereby be supplied for example via connection terminals into the fuel cell stack or the fuel cells.

The alternating voltage which is used to supply the alternating current and is applied by the alternating voltage generating device to the fuel cell stack or the fuel cells can have any curved or rectangular shape. There are included herein for example a pure sinusoidal alternating voltage or a pure rectangular alternating voltage. However it is also possible likewise that an intermediate shape between the two extremes of the pure rectangular shape and the pure sinusoidal shape can be used. The pure rectangular shape thereby confers the advantage that the fuel cell can be brought most rapidly to the operating or switch-on temperature. On the other hand, there is the disadvantage with the pure rectangular shape that very high currents flow at the edges of the rectangular voltage. It is therefore preferred to choose a curved shape which has a shape approaching the rectangular shape but is rounded-off at the edges. As an intermediate shape between the rectangular shape and the sinusoidal shape, this preferred shape should be allocated to the rectangular shape. Likewise, a trapezoidal shape is however also possible.

According to the electrical capacitance of the fuel cell stack to be heated, also resonant methods can be used to supply the alternating current.

A preferred embodiment of the fuel cell system according to the invention has an alternating voltage generating device which is constructed from an alternating voltage source and a direct voltage source which is connected electrically in series to the alternating voltage source. It is thereby possible that the alternating- and the direct voltage source are integrated in one unit or the alternating voltage generating device contains a single device which has both functions at the same time.

A preferred variant provides that the alternating and direct voltage sources are produced by a power-electronic circuit. This can comprise for example a step-down converter, a step-up converter, an inverse converter, a SEPIC (single-ended primary inductance converter), a Cuk converter and/or a circuit related thereto.

A bi-directional circuit which can be used both for heating the fuel cell stack and for converting the output voltage (DC/DC converter) in the normal fuel cell operation is particularly preferably used.

A further preferred variant provides that the alternating voltage generating device has an alternating voltage source and a condenser which is connected electrically in series to the alternating voltage source.

It is thereby preferred that an alternating voltage with an amplitude of 0.2 V to 0.6 V, preferably 0.3 V to 0.5 V and particularly preferred 0.35 V to 0.45 V, per fuel cell of the fuel cell stack, is superimposed upon the no-load voltage or the operating voltage of the fuel cell stack by the alternating voltage generating device.

An alternating voltage with a frequency of 10 Hz to 10 MHz, preferably from 100 Hz to 1 MHz and particularly preferred 1 kHz to 100 kHz, can be generated by the alternating voltage generating device.

Preferably, an alternating voltage can be applied to the fuel cell stack by the alternating voltage generating device by means of a redundant method. The capacitance of the series condenser is thereby dependent upon the fuel cell size and the frequency of the alternating voltage and is preferably in the range between 1 μF to 10 F.

Relative to the state of the art, the fuel cell system according to the invention has in particular the advantages that the heat production is effected directly in the fuel cell and no heating of additional components or masses is required. This means that further components, such as e.g. a heating element, can be dispensed with. According to the embodiment of the required voltage converter for stabilisation of the output voltage, i.e. for supplying the connected consumer units, the latter can be designed bi-directionally and take over the heating of the fuel cell. A further advantage of the fuel cell system according to the invention is based on the fact that air cooling of the fuel cells is also possible.

According to the invention, a heating method for heating a fuel cell stack which has at least one fuel cell is likewise provided. In this method, an alternating current is supplied to at least one of the individual cells of the fuel cell stack, the previously described fuel cell system being used preferably.

A fuel cell system according to the invention can be configured or used as described in one of the subsequent examples. The Figures which are associated with the example and described subsequently have identical reference numbers for the same or similar components or parts.

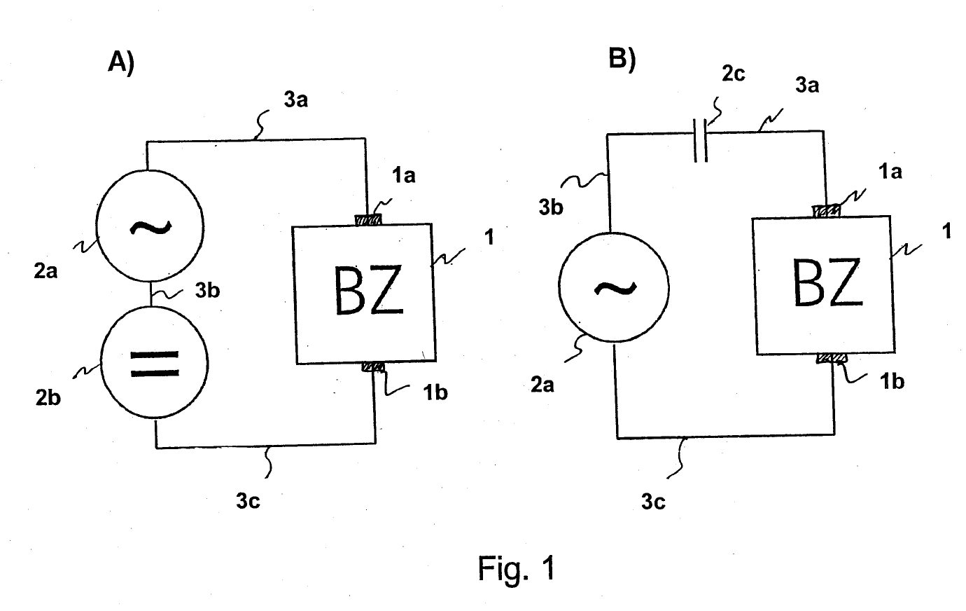

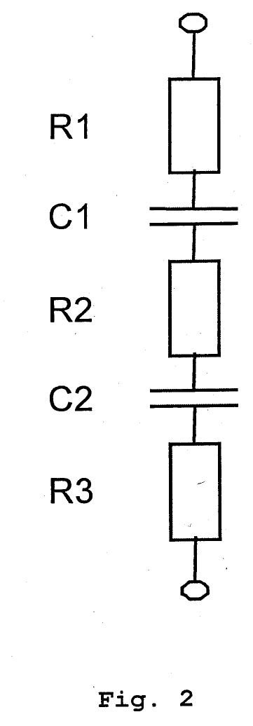

FIG. 1 a shows schematically a first fuel cell system according to the invention with a direct voltage source and an alternating voltage source which are connected in series for heating.

FIG. 1b shows a second example of a fuel cell system according to the invention with an alternating voltage source which is connected in series to a condenser.

FIG. 2 shows a simple substitute circuit diagram of a fuel cell stack with two individual cells in series.

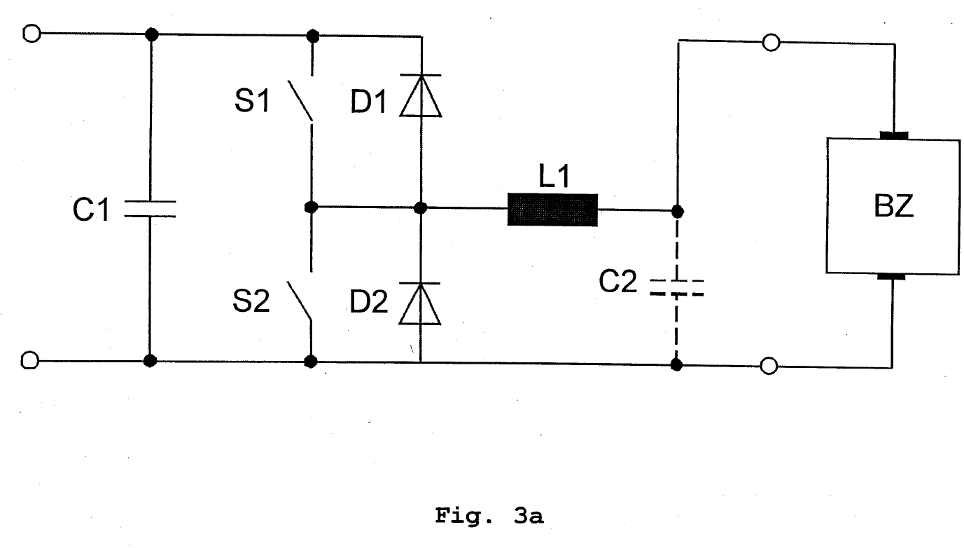

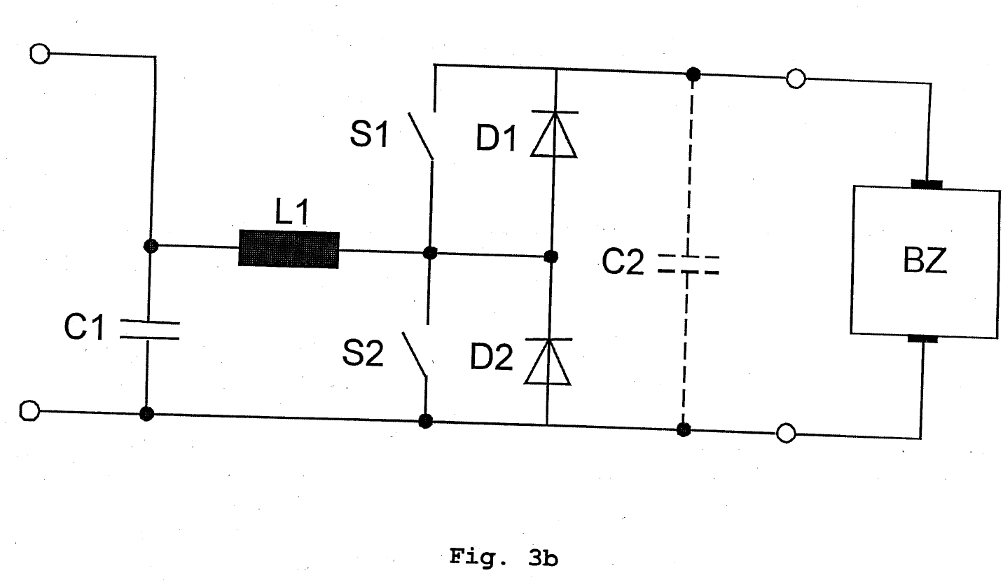

FIG. 3a shows a first variant according to the invention of a bi-directional, power-electronic circuit.

FIG. 3b shows a second variant of a bi-directional, power-electronic circuit according to the invention.

In FIG. 1a, the reference number 1 designates a fuel cell stack which, in the present case, has six individual fuel cells which are connected in series. The fuel cell stack can however also have more or fewer fuel cells, the fuel cells being able also to be connected in parallel. The fuel cell stack is provided with two electrical connections 1a and 1b in the form of connection terminals, via which an electrical consumer unit can be connected to the fuel cell stack. In the present case, the connection 1a is connected via an electrical line 3a to a first connection of an alternating voltage source 2a. The other electrical connection of the alternating voltage source 2a is connected via a further electrical line 3b to a first connection of a direct voltage source 2b. The second connection of the direct voltage source 2b is connected via an electrical line 3c to the second connection 1b of the fuel cell stack 1. It is likewise also possible that the alternating voltage source and the direct voltage source are disposed in reverse sequence since the sequence of the individual integrated voltage sources is arbitrary. In the present case, the alternating current heating or alternating voltage generating device 2 for the fuel cell stack is therefore configured such that an alternating voltage source 2a and a direct voltage source 2b (which establishes the operating point) are connected in series. The voltage generated by the voltage sources is applied via the connection terminals 1a and 1b to the fuel cell stack 1, as a result of which an alternating current is supplied directly via the connection terminals of the fuel cell stack 1 into the individual fuel cells of the stack. Due to the ohmic resistance of the stack, heating is therefore effected directly in the interior of the fuel cell stack. The applied voltage is hereby chosen for example such that an alternating voltage with an amplitude of 0.4 V per fuel cell of the fuel cell stack 1 is superimposed upon the no-load voltage or the operating voltage of the fuel cell stack 1. Since the stack has six individual fuel cells in the present case, hence an alternating voltage with an amplitude of 2.4 V is superimposed upon the fuel cell stack. However, also larger or smaller amplitude values can be applied.

The curved shape of the applied alternating voltage can hereby be chosen to be sinusoidal or even rectangular in order to increase the power. A shape of the alternating voltage which is based on a rectangular shape, but is rounded-off at the edges by a sinusoidal superimposition is preferred here. The frequency of the applied alternating voltage is freely selectable within wide ranges, particularly advantageously frequencies are between 10 Hz and 10 MHz. As already described, also resonant methods can be applied according to the capacitance of the fuel cell stack.

FIG. 1b shows a further embodiment of alternating current heating according to the invention. The alternating voltage generating device 2 hereby has an alternating voltage source 2a and a condenser 2c which is connected thereto in series via the electrical line 3b. The alternating voltage generating device is, as in FIG. 1a, connected via the two electrical lines 3a and 3c to the connection terminals 1a and 1c of the fuel cell stack 1. One or more consumer units which are connected via corresponding electrical connections to the fuel cell or to the fuel cell stack can be connected to the fuel cell via a separate circuit.

In FIG. 2, a substitute circuit diagram of a fuel cell stack comprising two fuel cells is represented, said stack comprising in the simplest form a series circuit of resistors and condensers. The resistors of the substitute circuit diagram are determined by the conductivity of the materials used and the condenser is formed by the bipolar plates and the membrane as dielectric. It is evident from the substitute circuit diagram that heating with direct current is not possible since the direct current cannot flow continuously through the condensers. For alternating current of a sufficiently high frequency, the condensers are however conductive or the impedance (Z=1/(ωC)) reduces so greatly that an alternating current can flow. At the ohmic resistors, this alternating current then produces an electrical power loss which heats the stack. This means that no additional components, such as e.g. heating foils, are required and the heating can therefore be effected directly in the stack where it is required.

FIG. 3a shows a bi-directional circuit according to the invention in which the bi-directional converter which is used operates as a step-down converter for heating the stack.

The direct voltage of the condenser C1 or of a direct voltage source or battery connected in parallel to C1 is converted by cycling of the electronic switches S1 and S2 into a controllable direct voltage with a superimposed alternating voltage. The alternating voltage component thereby effects the heating of the stack. During the normal fuel cell operation without heating, the stack is the energy source and the circuit operates as step-up converter and converts the direct voltage of the stack into a higher output voltage at the condenser C1. The electrical consumer units can be connected in parallel to C1. The condenser C2 can be connected optionally in parallel to the fuel cell stack in order to support the voltage and/or to smooth the currents.

In FIG. 3b, a second variant of a bi-directional circuit according to the invention is represented. In this variant, the bi-directional converter operates as step-up converter in order to heat the fuel cell stack.

The direct voltage of the condenser C1 or of a direct voltage source or battery connected in parallel to C1 is converted by cycling of the electronic switches S1 and S2 into a controllable direct voltage with a superimposed alternating voltage. The alternating voltage component thereby effects the heating of the stack. During the normal fuel cell operation without heating, the stack is the energy source and the circuit converts the direct voltage of the stack into a lower output voltage at the condenser C1. The electrical consumer units can be connected In parallel to C1. The condenser C2 can be connected optionally in parallel to the fuel cell stack in order to support the voltage and/or to smooth the currents.

1-22. (canceled)

23. A fuel cell system, comprising:
a fuel cell stack which has at least one fuel cell and has at least one electrical connection per terminal, wherein
the fuel cell stack is connected via at least one electrical connection to an alternating voltage generating device for electrical heating of the fuel cell stack, a rectangular alternating voltage which is rounded-off at the edges being generated by the alternating voltage generating device.

24. The fuel cell system according to claim 23, wherein the at least one electrical connection is suitable for connection of an external electrical consumer unit and/or is at least a connection terminal.

25. The fuel cell system according to claim 23, wherein the alternating voltage generating device has an alternating voltage source and a direct voltage source which is connected electrically in series to the alternating voltage source.

26. The fuel cell system according to claim 25, wherein the alternating voltage source and the direct voltage source are integrated in a single device.

27. The fuel cell system according to claim 25, wherein the alternating voltage source and the direct voltage source are produced by a power-electronic circuit.

28. The fuel cell system according to claim 27, wherein the power-electronic circuit is formed by a device taken from the group consisting of: a step-down converter, a step-up converter, an inverse converter, a SEPIC converter, and a Cuk converter.

29. The fuel cell system according to claim 27, wherein the power-electronic circuit is a bi-directional circuit for heating the fuel cell stack and for converting the output voltage in the fuel cell operation.

30. The fuel cell system according to claim 23, wherein the alternating voltage generating device has an alternating voltage source and a condenser, which is connected electrically in series to the alternating voltage source.

31. The fuel cell system according to claim 23, wherein:
an alternating voltage can be superimposed upon a no-load voltage or an operating voltage of the fuel cell stack by means of the alternating voltage generating device; and
the alternating voltage includes an amplitude, per fuel cell of the fuel cell stack, of one of: above 0.2 V and/or below 0.6 V; above 0.3 V and/or below 0.5 V; above 0.35 V and/or below 0.45 V; and 0.4 V.

32. The fuel cell system according to claim 23, wherein the alternating voltage generating device is operable to produce an alternating voltage with a frequency of one of: above 10 Hz and/or below 10 MHz; above 100 Hz and/or below 1 MHz; above 1 kHz and/or below 100 kHz.

33. The fuel cell system according to claim 23, wherein an alternating voltage can be applied to the fuel cell stack by the alternating voltage generating device by means of a resonant method.

34. The fuel cell system according to claim 23, wherein the fuel cell stack has at least two fuel cells which are connected electrically in series or at least two fuel cells which are connected electrically in parallel.

35. A heating method for heating a fuel cell stack which has at least one fuel cell, wherein an alternating current is supplied to at least one of the fuel cells of the fuel cell stack, a rectangular alternating current, which is rounded-off at edges thereof by a sinusoidal superimposition, being superimposed upon a no-load voltage or upon an operating voltage of the fuel cell stack in order to supply the alternating current.

36. The heating method according to claim 35, wherein a fuel cell system according to claim 1 is used.

37. The heating method according to claim 35, wherein the alternating current is supplied by applying an alternating voltage to at least one electrical connection, which can be used or is used for connection of at least one external consumer unit, in particular connection terminals, of the fuel cell stack.

38. The heating method according to claim 35, wherein the alternating current is supplied using an alternating voltage generating device, which has an alternating voltage source and a direct voltage source, which are connected electrically in series.

39. The heating method according to claim 35, wherein the alternating current is supplied using an alternating voltage generating device, which has an alternating voltage source and a condenser which are connected electrically in series.

40. The heating method according to claim 35, wherein in order to supply the alternating current there is superimposed upon a no-load voltage or upon an operating voltage of the fuel cell stack, an alternating voltage with an amplitude of one of: above 0.2 V and/or below 0.6 V; above 0.3 V and/or below 0.5 V; above 0.35 V and/or below 0.45 V; and 0.4 V, per fuel cell of the fuel cell stack.

41. The heating method according to claim 35, wherein in order to supply the alternating current there is superimposed upon a no-load voltage or upon an operating voltage of the fuel cell stack, an alternating voltage with a frequency in the range from one of: 10 Hz to 10 MHz; 100 Hz to 1 MHz; and 1 kHz to 100 kHz.

42. The heating method according to claim 35, wherein the alternating current or the alternating voltage is supplied or applied by means of a resonant method.
